(19) United States
(12) Patent Application Publication
(10) Pub. No.: US 2022/0245181 A1
(43) Pub. Date: Aug. 4, 2022

(54) READING COMPREHENSION SUPPORT SYSTEM AND READING COMPREHENSION SUPPORT METHOD

(71) Applicant: SEMICONDUCTOR ENERGY LABORATORY CO., LTD., ATSUGI-SHI, KANAGAWA-KEN (JP)

(72) Inventors: Yoshitaka DOZEN, Atsugi, Kanagawa (JP); Kazuki HIGASHI, Atsugi, Kanagawa (JP); Kunitaka YAMAMOTO, Atsugi, Kanagawa (JP)

(21) Appl. No.: 17/622,930

(22) PCT Filed: Jun. 22, 2020
(86) PCT No.: PCT/IB2020/055845

§ 371 Date: Dec. 27, 2021

(30) Foreign Application Priority Data
Jul. 5, 2019 (JP) 2019-126330

(51) Int. Cl. G06F 16/33; G06F 40/40; G06F 40/253; G06F 40/279

(52) U.S. Cl. CPC G06F 16/3344; G06F 40/279; G06F 40/253; G06F 40/40

(57) ABSTRACT

A reading comprehension support system or a reading comprehension support method that enables natural language to be input as query text and presents a reader with a part that is highly related to the input text is provided. The reading comprehension support system includes a document readout unit that reads out a subject document, a document division unit that divides the subject document into a plurality of blocks, a first distributed representation acquisition unit that acquires a distributed representation of a word in each of the plurality of blocks, a query text readout unit that reads out query text, a second distributed representation acquisition unit that extracts a word included in the query text and acquires a distributed representation of the word, and a similarity acquisition unit that compares distributed representations of words between the query text and each of the plurality of blocks and obtains similarity. From words included in the block, the similarity acquisition unit searches for a word that matches a word included in the query text, and obtains similarity between a distributed representation of the matching word in the block and a distributed representation of the matching word in the query text.

### TECHNICAL FIELD

One embodiment of the present invention relates to a document reading comprehension support system and a document reading comprehension support method.

### BACKGROUND ART

When a document is read and comprehended, how the document is read depends on the reader's purpose, or the type and the nature of the document. The reader may read through the entire document in some cases; in other cases, the purpose of reading may be finding information that the reader needs, in which cases it is sufficient for the reader if he/she finds the related part containing the necessary information from the document and reads only the related part. As a method for finding necessary information from a document, a table of contents or an index can be used. For a computerized document, a search with a keyword may be done to find desired information. In addition, a method of structurally analyzing a document in accordance with a set rule has been proposed (Patent Document 1).

### REFERENCE

### Patent Document

[Patent Document 1] Japanese Published Patent Application No. 2014-219833

### Non-Patent Document

[Non-Patent Document 1] BERT: Pre-training of Deep Bidirectional Transformers for Language Understanding, Devlin et al. (Submitted on 11 Oct. 2018 (v1), last revised 24 May 2019 (this version, v2)), [online], internet <URL:https://arxiv.org/abs/1810.04805v2>

### SUMMARY OF THE INVENTION

### Problems to be Solved by the Invention

In the case where a table of contents or an index are used, if the word to be found is not used directly in the table of contents or the index, the efficiency is low. Text search with a keyword enables a sentence or a paragraph that includes the keyword to be found from the entire document; however, desired information may not always be found efficiently. The reasons for not being able to find desired information efficiently are, for example; the keyword search gets so many hits that it takes too much time to reach the desired information, a single keyword is unable to narrow down the desired information, an appropriate keyword cannot be found, and the like. Furthermore, the document structural analysis in accordance with rules limits the structure of the subjects to be read, so that a document with a variety of structures is difficult to handle. One embodiment of the present invention solves at least one of the above issues.

An object of one embodiment of the present invention is to provide a reading comprehension support system or a reading comprehension support method that enables input of natural language as query text and presents a reader with a part that is highly related to the input text.

Note that the description of these objects does not preclude the existence of other objects. One embodiment of the present invention does not need to achieve all the objects. Other objects can be derived from the description of the specification, the drawings, and the claims.

### Means for Solving the Problems

One embodiment of the present invention is a reading comprehension support system including a document readout unit that reads out a subject document, a document division unit that divides the subject document into a plurality of blocks, a first distributed representation acquisition unit that acquires a distributed representation of a word in each of the plurality of blocks, a query text readout unit that reads out query text, a second distributed representation acquisition unit that extracts a word included in the query text and acquires a distributed representation of the word, and a similarity acquisition unit that compares distributed representations of words between the query text and each of the plurality of blocks and obtains similarity. From words included in the block, the similarity acquisition unit searches for a word that matches a word included in the query text, and obtains similarity between a distributed representation of the matching word in the block and a distributed representation of the matching word in the query text.

One embodiment of the present invention is a reading comprehension support method including a step of reading out a subject document, a step of dividing the subject document into a plurality of blocks, a step of acquiring a distributed representation of a word in each of the plurality of blocks, a step of reading out query text, a step of extracting a word included in the query text and acquiring a distributed representation of the word, and a step of comparing distributed representations of words between the query text and each of the plurality of blocks and obtaining similarity. In the step of obtaining similarity, a word that matches a word included in the query text is searched for from words included in the block, and for the matching word, similarity between a distributed representation of the word in the block and a distributed representation of the word in the query text is obtained.

The plurality of blocks may each include one or a plurality of paragraphs of the subject document.

The plurality of blocks can each include one or a plurality of sentences.

Acquisition of the similarity may be performed with respect to a predetermined part of speech only.

Acquisition of the similarity may be performed by calculating cosine similarity.

In the case where there is more than one matching word in the query text and the block, the sum of similarities of distributed representations of matching words may be a score of the block.

### Effect of the Invention

According to one embodiment of the present invention, a reading comprehension support system or a reading comprehension support method that enables input of natural language as query text and presents a reader with a part that is highly related to the input text can be provided.

Note that the description of these effects does not preclude the existence of other effects. One embodiment of the present invention does not need to have all these effects. Other effects can be derived from the description of the specification, the drawings, and the claims.

### BRIEF DESCRIPTION OF THE DRAWINGS

FIG. 1 is a diagram showing an example of a reading comprehension support system.

FIG. 2 is a flowchart showing an example of a reading comprehension support method.

FIG. 3 is a flowchart showing an example of a reading comprehension support method.

FIG. 4 is a diagram showing distributed representations of words.

FIG. 5 is a diagram showing an example of a similarity calculation method.

FIG. 6 is a diagram showing an example of hardware of a reading comprehension support system.

FIG. 7 is a diagram showing an example of hardware of a reading comprehension support system.

### MODE FOR CARRYING OUT THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments.

Note that in the structures of the invention described below, the same portions or portions having similar functions are denoted by the same reference numerals in different drawings, and description thereof is not repeated. Furthermore, the same hatch pattern is used for the portions having similar functions, and the portions are not especially denoted by reference numerals in some cases.

In addition, the position, size, range, or the like of each structure shown in drawings does not represent the actual position, size, range, or the like in some cases for easy understanding. Therefore, the disclosed invention is not necessarily limited to the position, size, range, or the like disclosed in the drawings.

### Embodiment 1

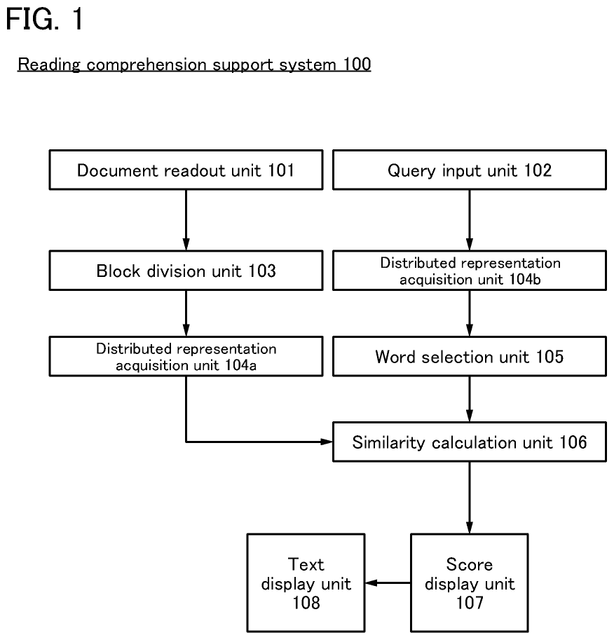

In this embodiment, a reading comprehension support system and a reading comprehension support method of one embodiment of the present invention will be described with reference to FIG. 1 to FIG. 5.

In the reading comprehension support method of this embodiment, a document that a user wants to read and comprehend (a subject document) and text related to the information the user needs (query text) are obtained first. The subject document is divided into a plurality of blocks (e.g., paragraphs), and distributed representations of words in each block are acquired. In addition, distributed representations of words included in the query text are acquired. Next, a word that matches a word included in the query text is searched from the words included in the block. Then, for the matching word, similarity between distributed representations of the word in the block and distributed representations of the word in the query text (e.g., cosine similarity) is obtained. When there is more than one matching word, the sum of similarities of distributed representations of the matching words is the score of the block. A block with a relatively high score is considered to be highly related to the query text. In this manner, a part that is highly related or similar to the information can be presented from the subject document. The blocks of the subject document can be arranged in descending order of score and presented in descending order of relevancy, for example.

In the reading comprehension support method of this embodiment, when a query in natural sentences is input, a part of the subject document, which is related to the query, can be presented. Different distributed representations are used even for the same word, in accordance with the text; thus, blocks that are more highly related or similar to the query can be presented.

A query can include one or more sentences. Since selection of a keyword to be used for search is unnecessary, a user can find desired information from the document with ease.

In this specification and the like, a document means a description of a phenomenon in natural language, which is computerized and machine-readable, unless otherwise described. Examples of a document include patent applications, legal precedents, contracts, terms and conditions, product manuals, novels, publications, white papers, and technical documents, but not limited thereto. In this specification and the like, text includes one or more sentences.

In this specification and the like, a word is the smallest language unit that has sound, a meaning, and a grammatical function. However, a distributed representation for a subword, a further-divided part of a word, may be obtained. For example, an English word “transformer” can be divided into two subwords, “transform” and “er”, and a distributed representation can be given to each of the subwords. Alternatively, it is also possible to give a distributed representation to a phrase composed of two or more words. In this specification and the like, subwords (divided parts of a word) are also referred to as words. In this specification and the like, a phrase, a word, or a subword to which a distributed representation is given is referred to as a token in some cases.

In this embodiment, a distributed representation of a word is acquired with the use of a language model in which different distributed representations are acquired for the same word depending on the distribution of surrounding words or the context. Alternatively, a distributed representation of a word is acquired with the use of a language model in which different distributed representations are acquired for the same word depending on the context. Furthermore, a language model in which a distributed representation where information of the position of a word in the text, a segment (information of sentence connection), and a token is embedded is obtained as a distributed representation of a word may be used. A language model with a self-attention function in which a distributed representation is acquired by bidirectional learning of the text may also be used. As an example of the language model in which different distributed representations are obtained for the same word depending on the distribution of surrounding words or the context, BERT (Bidirectional Encoder Representations from Transformers) (see Non-Patent Document 1) can be given.

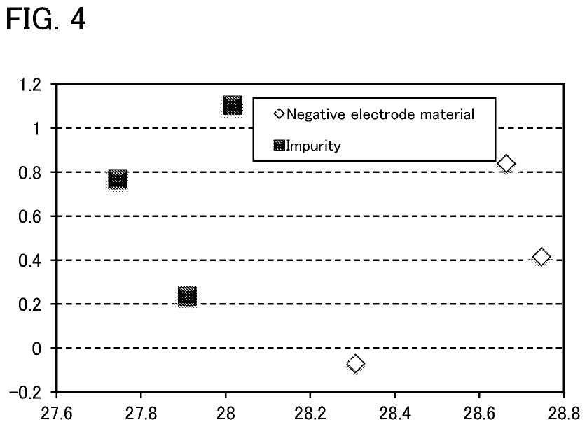

In FIG. 4, distributed representations acquired by BERT with respected to the word “carbon” included in six pieces of English text are plotted on X-Y coordinates. The three plots (square) on the left correspond to text including “carbon” as an impurity of a material, and three plots (diamond) on the right correspond to text concerning “carbon” as a negative electrode material. FIG. 4 is an example showing that different distributed representations are obtained for the same word “carbon”, depending on the contexts and text.

With the use of a language model with which different distributed representations of a word are obtained even for the same word, depending on the text in which the word is included, a block that is highly relevant to the information required by a user can be found with high precision. In the case where “carbon” as a negative electrode material is included in the query text, for example, the score of a block including “carbon” as a negative electrode material should be relatively high, whereas the score of a block including “carbon” as an impurity should be relatively low.

### [Reading Comprehension Support System]

FIG. 1 is a block diagram showing a configuration of a reading comprehension support system 100.

The reading comprehension support system 100 may be provided in a data processing device such as a personal computer used by a user. Alternatively, a processing unit of the reading comprehension support system 100 may be provided in a server to be accessed by a client PC via a network and used.

The reading comprehension support system 100 includes a document readout unit 101, a query input unit 102, a block division unit 103, a distributed representation acquisition unit 104a, a distributed representation acquisition unit 104b, a word selection unit 105, a similarity calculation unit 106, a score display unit 107, and a text display unit 108.

The document readout unit 101 reads out the document for reading and comprehension.

The document to be read out by the document readout unit 101 may be a document stored in a personal computer used by a user, or may be a document stored in a storage connected via a network.

The query input unit 102 is a unit where the user inputs text specified for search.

A query (also referred to as query text) can be input by directly inputting any given text or by copying and pasting text from a document file. Alternatively, a system in which the user voluntarily specifies a portion of the document read out by the document readout unit 101 so that the portion is read into the query input unit 102 may be adopted.

The block division unit 103 divides the read document into blocks. The block division unit 103 can be referred to as a document dividing unit.

In dividing the document into blocks, one paragraph may be regarded as one block, one sentence separated by a comma or a period may be regarded as one block, or a predetermined number of paragraphs or a predetermined number of sentences may be regarded as one block. Some documents originally include paragraph numbers, so the document may be divided into blocks in accordance with the paragraph numbers.

The distributed representation acquisition unit 104a processes the document, which is read out by the document readout unit 101, on a block-by-block basis, and acquires distributed representations of words included in the block.

The distributed representation acquisition unit 104b acquires distributed representations of words included in the text input in the query input unit 102.

It is preferable that the distributed representation acquisition unit 104a and the distributed representation acquisition unit 104b use the same language model, basically.

The word selection unit 105 is a unit that selects a word to be used for similarity calculation, from the words included in the input query.

It is possible to make every word selectable, a predetermined part of speech such as a noun selectable, or a free word of the user's choice selectable. The minimum number of words to be selected is one; even in the case where one word is selected, different distributed representations are obtained in accordance with the text or the context, so that scoring is possible.

The similarity calculation unit 106 calculates similarity to the query with the use of the distributed representations of words obtained by the distributed representation acquisition unit 104a and the distributed representation acquisition unit 104b, on a block-by-block basis. The similarity calculation unit 106 can be referred to as a similarity acquisition unit.

The score display unit 107 can display a score calculated by the similarity calculation unit 106.

The text display unit 108 can display the document read out by the document readout unit 101. The text display unit 108 may further display the text input to the query input unit 102.

The score display unit 107 and the text display unit 108 are preferably synchronized with each other. The display method of the subject document may be changeable in accordance with the score value; for example, the blocks of the text are arranged in descending order of score, or only the blocks with scores higher than or equal to a predetermined value are displayed.

### [Reading Comprehension Support Method]

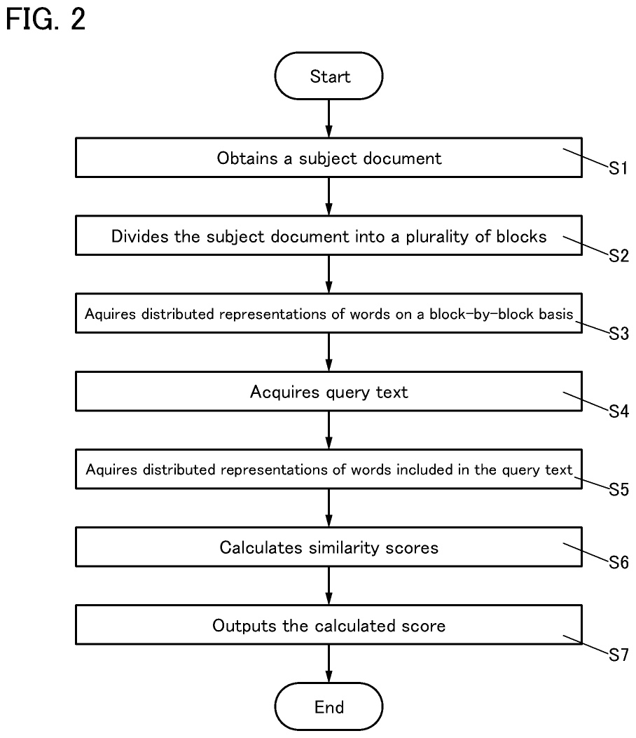

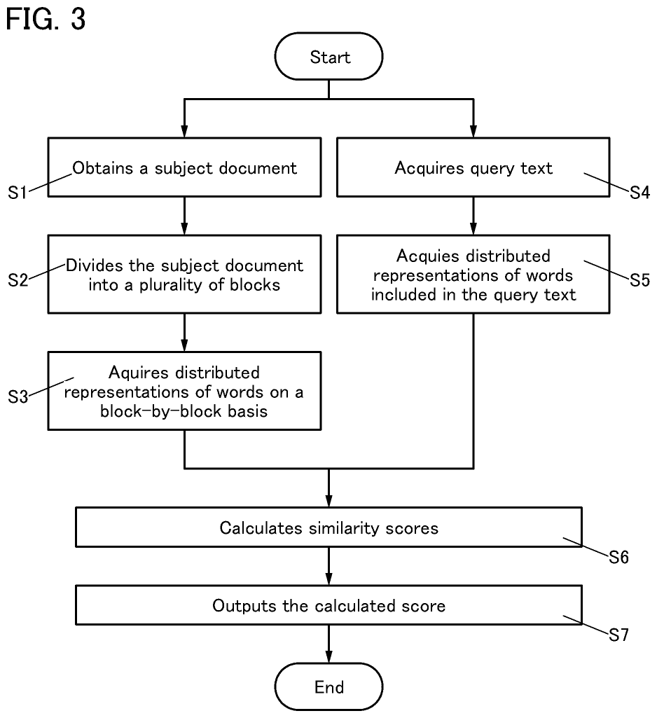

FIG. 2 and FIG. 3 are each a flowchart showing the flow of processing executed by the reading comprehension support system 100. That is, FIG. 2 and FIG. 3 are each a flowchart showing an example of the reading comprehension support method of one embodiment of the present invention.

### [Step S1: Obtains a Subject Document]

First, a subject document for reading and comprehension is read by the document readout unit 101 of the reading comprehension support system 100.

[Step S2: Divides the Subject Document into a Plurality of Blocks]

Next, the subject document is divided into a plurality of blocks by the block division unit 103.

### [Step S3: Acquires Distributed Representations of Words on a Block-by-Block Basis]

Next, text is input to the distributed representation acquisition unit 104a on a block-by-block basis, and distributed representations of words are acquired. Specifically, the subject document is input to a language model such as BERT on a block-by-block basis, and distributed representations of words are acquired.

### [Step S4: Acquires Query Text]

Then, query text is acquired by the query input unit 102 of the reading comprehension support system 100. The query text may be text voluntarily input by the user, or may be text of a part of the subject document where the user is highly concerned. FIG. 3 shows an example in which Step S4 and Step S5 are executed after Step S3; however, Steps S1 to S3 and Steps S4 and S5 can be executed independently of each other, in any order.

### [Step S5: Acquires Distributed Representations of Words Included in the Query Text]

Next, the query text is input to the distributed representation acquisition unit 104b, and distributed representations of words are acquired. Specifically, the query text is input to a language model such as BERT, and distributed representations of words are acquired.

### [Step S6: Calculates Block Scores]

Next, by the similarity calculation unit 106, the words included in each block and the words included in the query text are searched for matching words, and only when there are matching words, cosine similarity between the distributed representations of the matching words is calculated and the sum of cosine similarities in a block is calculated, whereby the block score is obtained.

It is also possible that words to be used for similarity calculation are selected from the words included in the query text by the word selection unit 105, and that only the selected words are subjected to similarity calculation.

Note that an example in which similarity is calculated using cosine similarity is described in this embodiment; however, other similarity calculation methods may also be used.

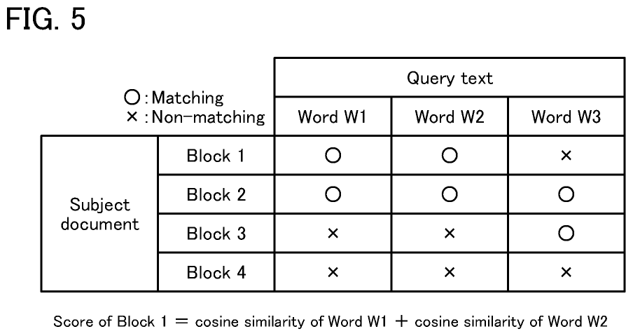

A method of calculating the score on a block-by-block basis will be described with reference to FIG. 5. FIG. 5 shows an example of comparing Block 1, Block 2, Block 3, and Block 4 of the subject document with the query text. First, in each block of the subject document, a word that matches a word in the query text is searched for, and cosine similarity of distributed representations of that matching word only is calculated. In the case where there is more than one matching word in one block, cosine similarities of the words are added, whereby the score of the block is calculated. In Block 1 shown in FIG. 5, for example, two words in the query text, Word W1 and Word W2, are matching words. In this case, the score of Block 1 is the sum of the cosine similarity of Word W1 and the cosine similarity of Word W2.

### [Step S7: Outputs the Calculated Score]

Then, the block with the calculated score being high can be presented to the user as the block that is highly likely to include desired information.

As described above, with the reading comprehension support system and the reading comprehension support method of this embodiment, when a document for reading and comprehension and text related to needed information are supplied by a user, a block in the document that is highly relevant to the information needed by the user can be presented. The user is not required to select a keyword, and finding desired information from the document becomes easy.

In the reading comprehension support system and the reading comprehension support method of this embodiment, a language model in which different distributed representations of words are obtained even for the same word, depending on the text included. Thus, a block that is highly relevant to the information required by a user can be found with high precision.

This embodiment can be combined with the other embodiments as appropriate. In this specification, in the case where a plurality of configuration examples are shown in one embodiment, the configuration examples can be combined as appropriate.

### Embodiment 2

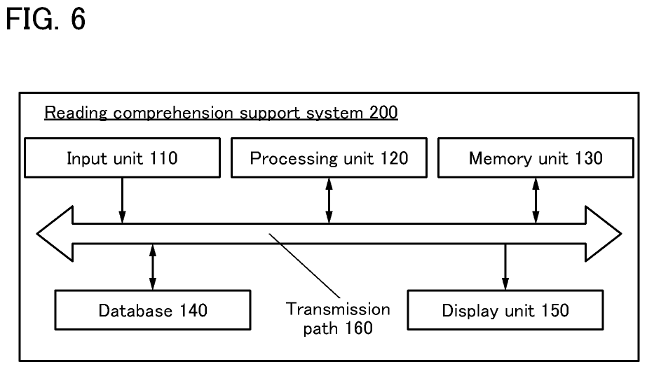

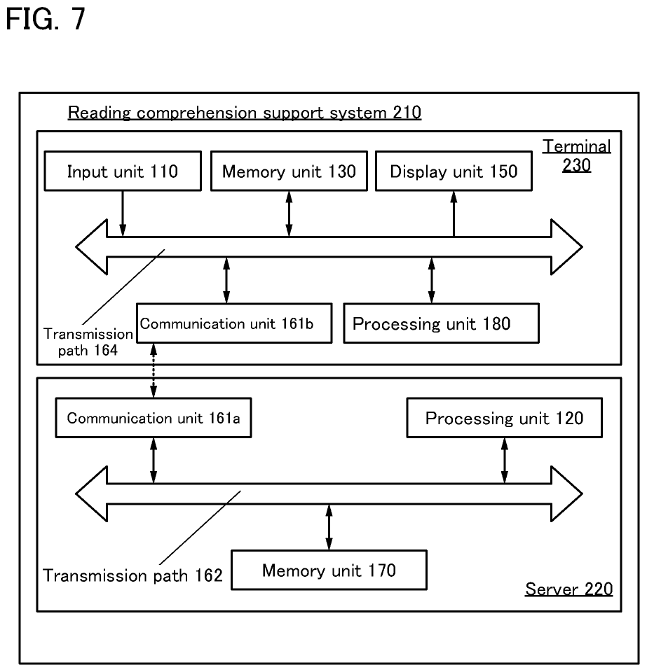

In this embodiment, a reading comprehension support system of one embodiment of the present invention will be described with reference to FIG. 6 and FIG. 7.

The reading comprehension support system of this embodiment makes it possible to search for and obtain desired information from a document easily, with the use of the reading comprehension support method described in Embodiment 1.

### Configuration Example 1 of Reading Comprehension Support System

FIG. 6 shows a block diagram of a reading comprehension support system 200. Note that in the drawings attached to this specification, the block diagram in which components are classified according to their functions and shown as independent blocks is illustrated; however, it is difficult to separate completely actual components according to their functions, and it is possible for one component to relate to a plurality of functions. Moreover, one function can relate to a plurality of components; for example, processing of a processing unit 120 can be executed on different servers depending on the processing.

The reading comprehension support system 200 includes at least the processing unit 120. The reading comprehension support system 200 shown in FIG. 6 further includes an input unit 110, a memory unit 130, a database 140, a display unit 150, and a transmission path 160.

### [Input Unit 110]

A query (query text) is supplied to the input unit 110 from the outside of the reading comprehension support system 200. The subject document may also be supplied to the input unit 110 from the outside of the reading comprehension support system 200. The subject document and the query text supplied to the input unit 110 are each supplied to the processing unit 120, the memory unit 130, or the database 140 through the transmission path 160.

The subject document and the query text are input in the form of text data, audio data, or image data, for example. The subject document is preferably input as text data.

Examples of a method for inputting the query text are key input with a keyboard, a touch panel, or the like, audio input with a microphone, reading from a recording medium, image input with a scanner, a camera, or the like, and obtainment via communication.

The reading comprehension support system 200 may have a function of converting audio data into text data. For example, the processing unit 120 may have the function. Alternatively, the reading comprehension support system 200 may further include an audio conversion unit having the function.

The reading comprehension support system 200 may have an optical character recognition (OCR) function. This enables characters contained in image data to be recognized and text data to be created. For example, the processing unit 120 may have the function. Alternatively, the reading comprehension support system 200 may further include a character recognition unit having the function.

### [Processing Unit 120]

The processing unit 120 has a function of performing an arithmetic operation with the use of the data supplied from the input unit 110, the memory unit 130, the database 140, or the like. The processing unit 120 can supply an arithmetic operation result to the memory unit 130, the database 140, the display unit 150, or the like.

The processing unit 120 has a function of dividing the document into a plurality of blocks. The processing unit 120 may have a function of dividing the document on a chapter-by-chapter basis, on a paragraph-by-paragraph basis, or every predetermined number of sentences, for example, into a plurality of blocks.

The processing unit 120 has a function of acquiring a distributed representation of a word. For example, the processing unit 120 can acquire a distributed representation of a word included in a block of the subject document or a word included in query text.

The processing unit 120 has a function of extracting a word from query text. Thus, a word to be used for the similarity calculation can be selected from words included in the query text.

The processing unit 120 has a function of calculating the similarity between distributed representations of words.

A transistor whose channel formation region contains a metal oxide may be used in the processing unit 120. The transistor has an extremely low off-state current; therefore, with the use of the transistor as a switch for retaining charge (data) which flows into a capacitor functioning as a memory element, a long data retention period can be ensured. When at least one of a register and a cache memory included in the processing unit 120 has such a feature, the processing unit 120 can be operated only when needed, and otherwise can be off while data processed immediately before turning off the processing unit 120 is stored in the memory element. Accordingly, normally-off computing is possible and the power consumption of the reading comprehension support system can be reduced.

In this specification and the like, a transistor including an oxide semiconductor in its channel formation region is referred to as an oxide semiconductor transistor or an OS transistor. A channel formation region of an OS transistor preferably includes a metal oxide.

The metal oxide included in the channel formation region preferably contains indium (In). When the metal oxide included in the channel formation region is a metal oxide containing indium, the carrier mobility (electron mobility) of the OS transistor increases. The metal oxide included in the channel formation region is preferably an oxide semiconductor containing an element M. The element M is preferably aluminum (Al), gallium (Ga), or tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that two or more of the above elements may be used in combination as the element M. The element M is an element having high bonding energy with oxygen, for example. The element M is an element having higher bonding energy with oxygen than indium, for example. The metal oxide contained in the channel formation region preferably contains zinc (Zn). The metal oxide containing zinc is easily crystallized in some cases.

The metal oxide included in the channel formation region is not limited to the metal oxide containing indium. The semiconductor layer may be a metal oxide that does not contain indium and contains zinc, a metal oxide that does not contain indium and contains gallium, a metal oxide that does not contain indium and contains tin, or the like, e.g., zinc tin oxide or gallium tin oxide.

Furthermore, a transistor containing silicon in a channel formation region may be used in the processing unit 120.

In the processing unit 120, a transistor containing an oxide semiconductor in a channel formation region and a transistor containing silicon in a channel formation region may be used in combination.

The processing unit 120 includes, for example, an arithmetic circuit, a central processing unit (CPU), or the like.

The processing unit 120 may include a microprocessor such as a DSP (Digital Signal Processor) or a GPU (Graphics Processing Unit). The microprocessor may be constructed with a PLD (Programmable Logic Device) such as an FPGA (Field Programmable Gate Array) or an FPAA (Field Programmable Analog Array). The processing unit 120 can interpret and execute instructions from various programs with the use of a processor to process various kinds of data and control programs. The programs to be executed by the processor are stored in at least one of a memory region of the processor and the memory unit 130.

The processing unit 120 may include a main memory. The main memory includes at least one of a volatile memory such as a RAM and a nonvolatile memory such as a ROM.

A DRAM (Dynamic Random Access Memory), an SRAM (Static Random Access Memory), or the like is used as the RAM, for example, and a memory space is virtually assigned as a work space for the processing unit 120 to be used. An operating system, an application program, a program module, program data, a look-up table, and the like which are stored in the memory unit 130 are loaded into the RAM and executed. The data, program, and program module which are loaded into the RAM are each directly accessed and operated by the processing unit 120.

In the ROM, a BIOS (Basic Input/Output System), firmware, and the like for which rewriting is not needed can be stored. As examples of the ROM, a mask ROM, an OTPROM (One Time Programmable Read Only Memory), an EPROM (Erasable Programmable Read Only Memory), and the like can be given. As the EPROM, a UV-EPROM (Ultra-Violet Erasable Programmable Read Only Memory) which can erase stored data by ultraviolet irradiation, an EEPROM (Electrically Erasable Programmable Read Only Memory), a flash memory, and the like can be given.

### [Memory Unit 130]

The memory unit 130 has a function of storing a program to be executed by the processing unit 120. The memory unit 130 may have a function of storing an arithmetic operation result generated by the processing unit 120, and data input to the input unit 110, for example.

The memory unit 130 includes at least one of a volatile memory and a nonvolatile memory. For example, the memory unit 130 may include a volatile memory such as a DRAM or an SRAM. For example, the memory unit 130 may include a nonvolatile memory such as an ReRAM (Resistive Random Access Memory), a PRAM (Phase change Random Access Memory), an FeRAM (Ferroelectric Random Access Memory), a MRAM (Magnetoresistive Random Access Memory), or a flash memory. The memory unit 130 may include a storage media drive such as a hard disc drive (HDD) or a solid state drive (SSD).

### [Database 140]

The reading comprehension support system may include the database 140. The database 140 has a function of storing a plurality of documents, for example. One of the documents stored in the database 140 may become the subject document, and the document may be read and comprehended with the use of the reading comprehension support method of one embodiment of the present invention, for example. Note that the memory unit 130 and the database 140 are not necessarily separated from each other. For example, the reading comprehension system may include a storage unit that has both the functions of the memory unit 130 and the database 140.

Note that memories included in the processing unit 120, the memory unit 130, and the database 140 can each be regarded as an example of a non-transitory computer readable storage medium.

### [Display Unit 150]

The display unit 150 has a function of displaying an arithmetic operation result obtained in the processing unit 120. The display unit 150 also has a function of displaying the subject document. The display unit 150 may also have a function of displaying query text.

The reading comprehension support system 200 may include an output unit. The output unit has a function of supplying data to the outside.

### [Transmission Path 160]

The transmission path 160 has a function of transmitting a variety of data. The data transmission and reception among the input unit 110, the processing unit 120, the memory unit 130, the database 140, and the display unit 150 can be performed through the transmission path 160. For example, data such as the subject document is transmitted and received through the transmission path 160.

### Configuration Example 2 of Reading Comprehension Support System

FIG. 7 shows a block diagram of a reading comprehension support system 210. The reading comprehension support system 210 includes a server 220 and a terminal 230 (e.g., a personal computer).

The server 220 includes a communication unit 161a, a transmission path 162, the processing unit 120, and a memory unit 170. The server 220 may further include an input/output unit or the like, although not illustrated in FIG. 7.

The terminal 230 includes a communication unit 161b, a transmission path 164, a processing unit 180, the memory unit 130, and the display unit 150. The terminal 230 may further include a database or the like, although not illustrated in FIG. 7.

A user of the reading comprehension support system 210 inputs a query (query text) to the input unit 110 of the terminal 230. The query is transmitted from the communication unit 161b of the terminal 230 to the communication unit 161a of the server 220.

The query received by the communication unit 161a passes through the transmission path 162 and is stored in the memory unit 170. Alternatively, the query may be directly supplied to the processing unit 120 from the communication unit 161a.

The block division, distributed representation acquisition, and similarity calculation described in Embodiment 1 each require high processing capability. The processing unit 120 included in the server 220 has higher processing capability than the processing unit 180 included in the terminal 230. Thus, the above processing is preferably performed by the processing unit 120.

Then, the score of a block is calculated by the processing unit 120. The score passes through the transmission path 162 and is stored in the memory unit 170. Alternatively, the score may be directly supplied to the communication unit 161a from the processing unit 120. The score is transmitted from the communication unit 161a of the server 220 to the communication unit 161b of the terminal 230. The score is displayed on the display unit 150 of the terminal 230.

### [Transmission Path 162 and Transmission Path 164]

The transmission path 162 and the transmission path 164 have a function of transmitting data. The communication unit 161a, the processing unit 120, and the memory unit 170 can transmit and receive data through the transmission path 162. The input unit 110, the communication unit 161b, the processing unit 180, the memory unit 130, and the display unit 150 can transmit and receive data through the transmission path 164.

### [Processing Unit 120 and Processing Unit 180]

The processing unit 120 has a function of performing an arithmetic operation with the use of data supplied from the communication unit 161a, the memory unit 170, or the like. The processing unit 180 has a function of performing an arithmetic operation with the use of data supplied from the communication unit 161b, the memory unit 130, the display unit 150, or the like. The description of the processing unit 120 can be referred to for the processing unit 120 and the processing unit 180. The processing unit 120 preferably has higher processing capacity than the processing unit 180.

### [Memory Unit 130]

The memory unit 130 has a function of storing a program to be executed by the processing unit 180. The memory unit 130 has a function of storing an arithmetic operation result generated by the processing unit 180, data input to the communication unit 161b, data input to the input/output unit 110, and the like.

### [Memory Unit 170]

The memory unit 170 has a function of storing a plurality of documents, an arithmetic operation result generated by the processing unit 120, the data input to the communication unit 161a, and the like.

[Communication Unit 161a and Communication Unit 161b]

The server 220 and the terminal 230 can transmit and receive data with the use of the communication unit 161a and the communication unit 161b. As the communication unit 161a and the communication unit 161b, a hub, a router, a modem, or the like can be used. Data may be transmitted or received through wire communication or wireless communication (e.g., radio waves or infrared rays).

This embodiment can be combined with the other embodiments as appropriate.

### REFERENCE NUMERALS

W1: word, W2: word, 1: block, 2: block, 3: block, 4: block, 100: reading comprehension support system, 101: document readout unit, 102: query input unit, 103: block division unit, 104a: distributed representation acquisition unit, 104b: distributed representation acquisition unit, 105: word selection unit, 106: similarity calculation unit, 107: score display unit, 108: text display unit, 110: input unit, 120: processing unit, 130: memory unit, 140: database, 150: display unit, 160: transmission path, 161a: communication unit, 161b: communication unit, 162: transmission path, 164: transmission path, 170: memory unit, 180: processing unit, 200: reading comprehension support system, 210: reading comprehension support system, 220: server, 230: terminal

1. A reading comprehension support system comprising:
a document readout unit that reads out a subject document;
a document division unit that divides the subject document into a plurality of blocks;
a first distributed representation acquisition unit that acquires a distributed representation of a word in each of the plurality of blocks;
a query text readout unit that reads out query text;
a second distributed representation acquisition unit that extracts a word included in the query text and acquires a distributed representation of the word; and
a similarity acquisition unit that compares distributed representations of words between the query text and each of the plurality of blocks and obtains similarity,
wherein, from words included in the block, the similarity acquisition unit searches for a word that matches a word included in the query text, and obtains similarity between a distributed representation of the matching word in the block and a distributed representation of the matching word in the query text.

2. The reading comprehension support system according to claim 1,
wherein the plurality of blocks each comprise one or a plurality of paragraphs of the subject document.

3. The reading comprehension support system according to claim 1,
wherein the plurality of blocks each comprise one or a plurality of sentences.

4. The reading comprehension support system according to claim 1,
wherein acquisition of the similarity is performed with respect to a predetermined part of speech only.

5. The reading comprehension support system according to claim 1,
wherein acquisition of the similarity is performed by calculating cosine similarity.

6. The reading comprehension support system according to claim 1,
wherein, in a case where there is more than one matching word in the query text and the block, the sum of similarities of distributed representations of matching words is a score of the block.

7. A reading comprehension support method comprising the steps of:
reading out a subject document;
dividing the subject document into a plurality of blocks;
acquiring a distributed representation of a word in each of the plurality of blocks;
reading out query text;
extracting a word included in the query text and acquiring a distributed representation of the word; and
comparing distributed representations of words between the query text and each of the plurality of blocks and obtaining similarity,
wherein, in the step of obtaining similarity, a word that matches a word included in the query text is searched for from words included in the block, and for the matching word, similarity between a distributed representation of the word in the block and a distributed representation of the word in the query text is obtained.

8. The reading comprehension support method according to claim 7,
wherein the plurality of blocks each comprise one or a plurality of paragraphs of the subject document.

9. The reading comprehension support method according to claim 7,
wherein the plurality of blocks each comprise one or a plurality of sentences.

10. The reading comprehension support method according to claim 7,
wherein acquisition of the similarity is performed with respect to a predetermined part of speech only.

11. The reading comprehension support method according to claim 7,
wherein acquisition of the similarity is performed by calculating cosine similarity.

12. The reading comprehension support method according to claim 7,
wherein, in a case where there is more than one matching word in the query text and the block, the sum of similarities of distributed representations of matching words is a score of the block.
